(19) United States
(12) Patent Application Publication
(10) Pub. No.: US 2015/0308982 A1
(43) Pub. Date: Oct. 29, 2015

(54) ULTRASOUND METHOD AND DEVICE FOR INSPECTING THE BULK OF A WELD FOR THE PRESENCE OF DEFECTS

(71) Applicant: AREVA, Courbevoie (FR)

(72) Inventor: Gilles PERRIN, Versailles (FR)

(21) Appl. No.: 14/648,157

(22) PCT Filed: Dec. 9, 2013
(86) PCT No.: PCT/EP2013/075957

§ 371 Date: May 28, 2015

(30) Foreign Application Priority Data
Dec. 12, 2012 (FR) 1261976

(51) Int. Cl. G01N 29/04

(52) U.S. Cl. CPC G01N 29/043; G01N 2291/044; G01N 2291/0234

(57) ABSTRACT

An ultrasound method and device for inspecting the bulk of a weld for the presence of defects are provided. The method includes a step of studying the weld metallurgically; a step of dividing the weld into a plurality of theoretical blocks and of jointly determining an elastic Hooke tensor for each theoretical block; a step of simulating by calculation the propagation of at least one incident ultrasound wave through the weld; a step of simulating at least one reference diffracted ultrasound wave; a step of emitting at least one incident ultrasound wave into the weld; a step of measuring each diffracted ultrasound wave; and a step of comparing each reference diffracted ultrasound wave with each measured diffracted ultrasound wave.

The present invention relates to the field of nondestructive ultrasound defect inspection, applied to certain zones of industrial apparatuses, for example nuclear reactors.

The present invention more particularly relates to an ultrasound bulk inspection method to determine the presence of defects in a weld.

The invention also relates to an ultrasound bulk inspection device for determining the presence of defects in a weld.

### BACKGROUND

Bulk inspection methods of the aforementioned type are known from the state of the art. Such methods make it possible to detect the presence of defects in a weld and to dimension those defects under certain conditions, for example using techniques of the “Time Of Flight Diffraction” (TOFD) type. These methods are based on the principle of the diffraction of an ultrasound wave beam caused by the presence of a defect perpendicular to the surface of the weld and situated on the trajectory of the waves.

In this type of method, an ultrasound wave transmitter and receiver are placed on the surface, near the weld, such that their respective beams are divergent enough to cover a significant part of the weld. The receiver then measures the shortest travel time of the ultrasound waves transmitted by the transmitter and propagating within the weld. The travel time corresponds to the time separating the transmission of the waves by the transmitter from their reception by the receiver.

If a planar defect is present within the weld, that defect diffracts part of the transmitted waves. The receiver receives the waves diffracted by the defect and measures the travel time of the shortest path of those waves. The comparison between the respective travel times of the diffracted waves and the non-diffracted waves then makes it possible to detect a defect. Applying trigonometric formulas next makes it possible to localize the defect in the weld, or to characterize some of its dimensions, such as its length or depth.

### SUMMARY OF THE INVENTION

The use of this type of method for a weld made from a metal material having a grain size of approximately the wavelength used nevertheless leads to results that are difficult to interpret, the structure of such a weld disrupting the propagation of the ultrasound beam. This is for example the case for a weld whereof the filler metal is an austenitic stainless steel or a nickel-based alloy. The prior art methods of the TOFD type then do not allow a minute characterization of the defects of the weld. Other inspection methods are used for this type of weld, for example radiography methods, which are less precise regarding the dimensioning of the defects and require usage precautions due to the ionizing radiation that is used.

One aim of the invention is therefore to provide an ultrasound bulk inspection method making it possible to obtain a minute detection and characterization of the defects of a weld, with sufficient precision irrespective of the size of the grains of the metal material of the weld.

To that end, an ultrasound method for inspecting the bulk of a weld for the presence of defects is provided, comprising:
a step for studying the weld metallurgically,
an experimental step for dividing, based on the metallurgical study, the weld into a plurality of theoretical blocks, and jointly determining a uniform elastic Hooke tensor for each theoretical block, the theoretical blocks being chosen so that the elastic Hooke tensor of each block is substantially homogenous and anisotropic in that block;
a step for simulating, by calculating the propagation of at least one incident ultrasound wave in the weld using the theoretical blocks and the elastic Hooke tensors determined experimentally, each incident ultrasound wave forming, after having crossed through the weld, a diffracted ultrasound wave;
a step for determining at least one reference diffracted ultrasound wave as a function of the propagation simulated during the simulation step;
a step for transmitting at least one incident ultrasound wave in the weld;
a step for measuring each diffracted ultrasound wave at least at one predetermined point; and
a step for comparing each reference diffracted ultrasound wave with each measured diffracted ultrasound wave, to deduce therefrom whether the weld has a defect.

Advantageously, the bulk inspection method according to embodiments of the invention makes it possible to completely dimension a defect present in a weld and does not require any particular usage precaution by an operator.

According to other advantageous aspects of the invention, embodiments of the bulk inspection method comprises one or more of the following features, considered alone or according to all technically possible combinations:
during the step for simulating, by calculation, the propagation of the incident ultrasound wave(s), weld defect types are modeled using defect models, each defect model comprising characteristics associated with a respective defect type;
each defect model is encapsulated in a software container, the software container further including a simulated measurement imprint associated with said defect type, each software container being able to be stored in a database;
each reference diffracted ultrasound wave is associated with a software container, the method further including a step for characterizing a defect, during which a defect detected during the comparison step is characterized, and a step for displaying the results, during which the characterized defect is retrieved in the form of display data indicative of a defect type, and display data indicative of a related presence relevance level;
the experimental step comprises transmitting at least one acoustic identification wave per family of theoretical blocks;
the frequency of each identification wave varies during the transmission;
a plurality of identification acoustic waves is transmitted, the frequencies of the transmitted identification waves being different in pairs;
each theoretical block has a volume larger than 0.1 mm³.

The invention also relates to an ultrasound device for inspecting the bulk of a weld for the presence of defects, the weld comprising a plurality of theoretical blocks, the device comprising:
means for transmitting at least one incident ultrasound wave in the weld, each incident ultrasound wave forming, after having passed through the weld, a diffracted ultrasound wave;
means for measuring the diffracted ultrasound wave(s) at least at one predetermined point;
an information processing unit connected to the transmission means, the processing unit being able to determine at least one reference diffracted ultrasound wave, compare each reference diffracted ultrasound wave with each measured diffracted ultrasound wave, and deduce therefrom whether the weld has a defect, the processing unit including processing means able to determine the theoretical blocks of the weld experimentally, as well as elastic Hooke tensors associated with the theoretical blocks, to be simulated by calculating the propagation of the incident ultrasound wave(s) by using the elastic Hooke tensors determined experimentally and deduce each reference diffracted ultrasound wave therefrom.

According to other advantageous aspects of the invention, embodiments of the bulk inspection device comprises one or more of the following features, considered alone or according to any technically possible combination(s):
the processing unit includes storage means able to store a database comprising a plurality of software containers;
each software container includes a defect model comprising characteristics associated with a defect type, and a simulated measurement imprint associated with said defect type; and
the device includes means for characterizing the detected defects and means for displaying the results of the inspection.

### BRIEF SUMMARY OF THE DRAWINGS

These features and advantages of the invention will appear upon reading the following description, provided solely as a non-limiting example, and done in reference to the appended drawings, in which:

FIG. 1 is a diagrammatic illustration of a bulk inspection device according to an embodiment of the invention, able to detect the presence of defects in a weld;

FIG. 2 is a flowchart showing the bulk inspection method according to an embodiment of the invention, implemented by the bulk inspection device of FIG. 1; and

FIG. 3 is a diagrammatic illustration of the weld of FIG. 1, divided, during the bulk inspection method, into several theoretical blocks that are anisotropic and substantially homogenous.

### DETAILED DESCRIPTION

In the rest of the description, the terms “right”, “left”, “top”, “bottom”, “longitudinal” and “transverse” are to be understood in reference to the system of orthogonal axes shown in the figures and having:
a longitudinal axis X oriented from bottom to top, and
a transverse axis Y oriented from left to right.

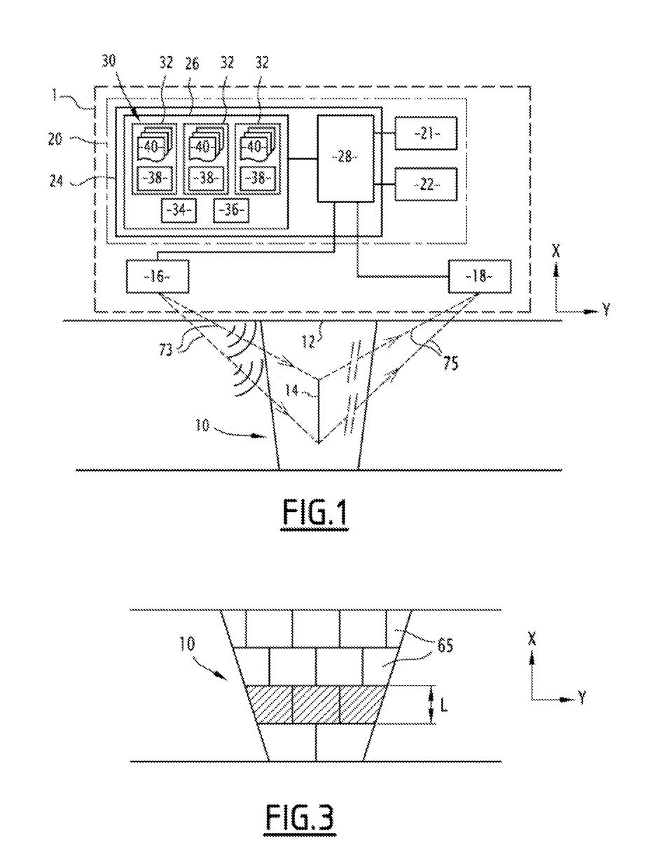

A device 1 for inspecting the bulk of a weld 10 for the presence of defects is diagrammatically illustrated in FIG. 1.

Such a weld 10 is for example present in a zone of a nuclear reactor, in particular in a piece of pressurized equipment in contact with the primary cooling fluid of the core of the reactor. The weld 10 is formed by a three-dimensional aggregate of grains of metal material joined to one another. In the illustrated example embodiment, the metal material is an austenitic stainless steel, the grains of which are needles, each needle having a diameter substantially equal to 100 μm and a length substantially equal to 1 mm. The weld 10 has a substantially parallelepiped shape. The height of the weld 10 is defined as the dimension of the weld parallel to the axis X, the width being defined as the dimension of the weld parallel to the axis Y. The weld 10 has a height for example substantially equal to 10 cm and a width for example substantially equal to 1 cm.

In FIG. 1, the weld 10 is seen in a sectional view in plane X-Y and includes a defect 14, for example a crack. Only an outer surface 12 of the weld 10 is visible from the outside, the surface 12 extending in a transverse plane, perpendicular to the axis X. The crack 14 for example extends in the plane X-Y, perpendicular to the surface 12.

The bulk inspection device 1 according to the embodiment of the invention shown in FIG. 1 includes an ultrasound transmitter 16, an ultrasound receiver 18, and an information processing device 20, connected to the transmitter 16 and the receiver 18.

The transmitter 16 is for example a longitudinal wave transducer operating in transmission mode. The transmitter 16 is able to transmit longitudinal ultrasound waves toward the weld 10. It is in particular able to transmit waves whereof the wavelength is approximately the wavelength of the grains of metal material, in other words with a frequency for example substantially equal to 3 MHz in the example embodiment.

The receiver 18 is for example a longitudinal wave transducer operating in reception mode. The receiver 18 is able to receive, at a predetermined point, ultrasound waves transmitted by the weld 10 and transform those waves into a digital response signal Sr(t). It is in particular able to receive, at a predetermined point, ultrasound waves diffracted by the defect 14 of the weld 10. The receiver 18 is further able to measure the travel time of the shortest path of an ultrasound wave transmitted by the transmitter 16 and propagating within the weld 10, to the receiver 18.

The information processing device 20 includes a data input peripheral 21, a retrieval interface 22 and an information processing unit 24, connected to the peripheral 21 and the interface 22. The processing device 20 is, for example, a portable computer able to be used by an operator near the weld 10. The processing device 20 is able to command the transmitter 16 by sending it a command signal corresponding to one or more acoustic waves to be transmitted.

The data input peripheral 21 is for example a data entry terminal. The input peripheral 21 is in particular able to allow an operator to enter characteristics relative to a weld, such as a weld type, weld shape, or dimension, for example. The input peripheral 21 is also able to allow the entry, by an operator, of characteristics relative to a given defect type, such as the size of the defect or the orientation of the defect.

The retrieval interface 22 is formed by any type of information display means, for example a display screen.

Traditionally, the processing unit 24 is formed by a memory 26 associated with a data processor 28. The memory 26 is for example able to store a database 30 comprising several software containers 32. The memory 26 is further able to store a first software program 34 able to carry out steps for inspecting the weld 10, and a second software program 36 for outlining an elastodynamic radius in a heterogeneous medium.

Each software container 32 comprises a defect model 38 and an associated imprint of simulated measurements. Each defect model 38 comprises a data set associated with a given type of defect, for example the dimension of the defect or the orientation of the defect. The data set from a defect model 38 makes it possible to characterize the associated defect type completely. A measurement imprint refers to a set of lists 40 of data relative to the same type of defect, each list 40 being associated with a simulated measurement and comprising several characteristic parameters relative to that measurement.

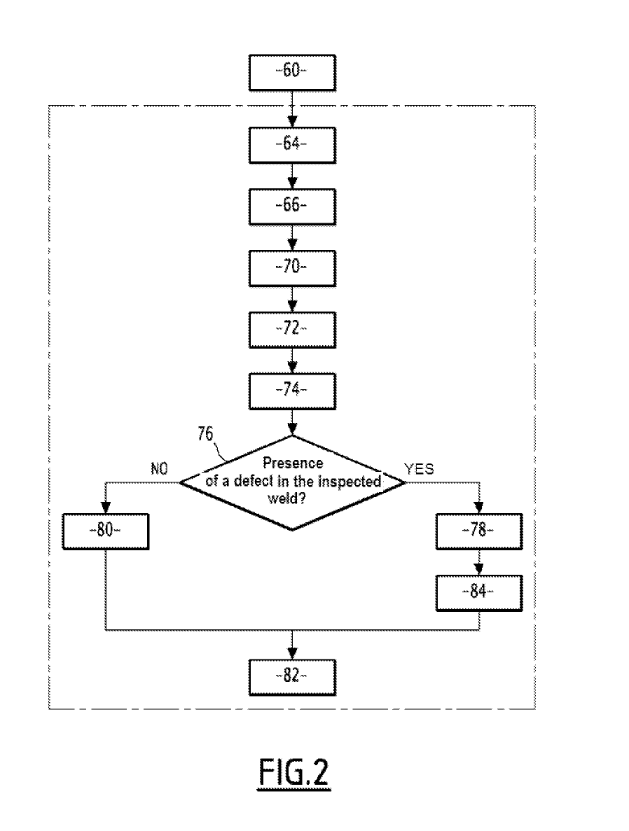

The first software program 34 makes it possible, based on several wave measurements, to carry out steps for dividing the weld 10 into theoretical blocks with determination of uniform elastic Hooke tensors in each theoretical block, determining reference ultrasound waves, comparing the reference ultrasound waves with measured ultrasound waves, characterizing defects and displaying results. These steps are described below in reference to FIG. 2.

The second software program 36 is able to carry out a step for simulating the propagation of ultrasound waves in the weld 10, as also described below in light of FIG. 2.

The data processor 28 is connected to the transmitter 16, the receiver 18, the input peripheral 21 and the retrieval interface 22 and is able to implement the software programs 34, 36.

In an alternative embodiment, the bulk inspection device 1 includes several transmitters 16 and several receivers 18, each transmitter 16 being associated with a single respective receiver 18, and vice versa. Each transmitter 16 and each receiver 18 is connected to the information processing device 20.

Also alternatively, the information processing device 20 is not connected to the receiver 18. According to this alternative embodiment, the input peripheral 21 is further able to allow the entry, by an operator, of data relative to measurements of ultrasound waves transmitted by the transmitter 16, passing through the weld 10 and received by the receiver 18. The input peripheral 21 is for example able to allow the entry, by an operator, of the travel time of the shortest path of those waves.

The bulk inspection method of the weld 10 according to an embodiment of the invention will now be described in reference to FIG. 2.

During a prior study step 60, an operator performs a metallurgical study of several standard welds, for example by taking a sample from each weld, then analyzing each sample using a method for metallurgical analysis and visualization of the grain structure that is known in itself, for example a method of the EBSD type (Electron Back Scattering Diffraction). A standard weld here refers to a weld characteristic of a given weld type, each weld type being distinguished by the nature of the materials used and/or the weld method used and/or the shape of the weld. This step is for example carried out in a laboratory adapted to performing this type of analysis. During this study operation 60, the operator in particular performs a metallurgical study of the weld type corresponding to the weld 10.

The operator next uses the results of the metallurgical analysis to identify a characteristic dimension L relative to the weld 10. The characteristic dimension L makes it possible to divide the weld 10 into theoretical blocks 65 that are approximately homogenous for the propagation of waves, as outlined below. During this same study step 60, the operator takes the weld inspection device 1 and enters, in the input peripheral 21 of the device 1, for each studied standard weld, the characteristic dimension L of the theoretical blocks for that standard weld. The characteristic dimension L of the blocks for each studied standard weld is then sent to the memory 26 of the processing unit 24, which stores it.

The characteristic dimension L of the box generally depends on the dimension of the weld in a same direction as that in which the characteristic dimension L is measured, in particular the direction parallel to the axis X. For example, the dimension L is comprised between 1% and 10% of said dimension of the weld in the same direction. For example, for a weld extending over a height of 70 mm, the characteristic dimension L is for example substantially equal to 3 mm.

The characteristic dimension L is preferably greater than 0.5 mm. Consequently, the volume of each theoretical block is preferably greater than 0.1 mm³.

The steps of the method implemented by the device 1 will now be described.

During a subsequent experimentation step 64, the operator positions the bulk inspection device 1 near the top of the weld 10, across from the outer surface 12. The transmitter 16 and the receiver 18 are positioned at equal distances from the weld 10, on either side of the weld 10, as illustrated in FIG. 1. The operator next enters the type and shape of the weld 10 in the input peripheral 21 of the bulk inspection device 1.

From the type and shape of the weld entered into the input peripheral 21, the data processor 28 identifies the characteristic dimension L of the theoretical blocks of the weld 10, by matching with the characteristic dimension values stored in the memory 26. The data processor 28 next generates a division of the weld 10 into theoretical blocks 65, as illustrated in FIG. 3, then implements the first software program 34.

The information processing device 20 then sends the transmitter 16 a command signal to transmit several acoustic identification waves. The transmitter 16 next insonifies the entire weld 10 with the acoustic identification waves. Preferably, the frequency of each identification transmitted wave varies over the course of the transmission of those waves. It for example goes from a value substantially equal to 1 MHz at the beginning of transmission to a value substantially equal to 10 MHz at the end of transmission.

In the alternative where the bulk inspection device 1 includes several transmitters 16 and several receivers 18, it is also possible to perform this wave transmission step by transmitting several acoustic identification waves, the frequencies of the transmitted identification waves being different in pairs. Each acoustic wave is transmitted, then received by a separate transmitter-receiver pair. According to this alternative, the number of transmitter-receiver pairs is adapted to the number of acoustic outlines necessary.

The receiver 18 next receives the waves transmitted by the transmitter 16 after they have been propagated in the weld 10, and determines a digital response signal Sr₁(t). The receiver 18 sends the digital response signal Sr₁(t) to the information processing unit 24.

In the alternative in which the information processing device 20 is not connected to the receiver 18, the operator enters data measured by the receiver 18 into the input peripheral 21, that data being related to the waves transmitted by the transmitter 16 and propagating in the weld 10. The operator for example enters the travel time of the shortest path of the transmitted waves in the input peripheral 21.

The processor 28 then implements the first software program 34. Upon instruction from an algorithm of the first software program 34, the processor 28 identifies the best division of the weld 10 into theoretical blocks 65 with a characteristic size L identified beforehand, and jointly determines a uniform Hooke tensor for each block.

The theoretical blocks 65 have a substantially identical characteristic dimension L.

Alternatively, the theoretical blocks 65 may have variable characteristic dimensions depending on the considered zones of the weld 10. In that case, the characteristic dimension L is known and predetermined for each zone of the weld 10.

Preferably, the theoretical blocks each have a substantially hexahedral shape and the characteristic dimension L is the height of the block, i.e., its dimension parallel to the axis X. The determination of the size of the theoretical blocks is done such that the elastic Hooke tensor of each block is substantially homogenous and anisotropic. In other words, the structure of the ultrasound wave propagation speeds is substantially homogenous in each block.

The algorithm of the first software program 34 is for example an algorithm used in traditional acoustic tomography methods. The processor 28 sends the values of the uniform Hooke tensors of the theoretical blocks 65 to the memory 26, which stores them. The steps for sending identification waves, receiving the resulting waves, then processing the transmitted signal are for example traditional steps in an acoustic tomography method known in itself.

The prior determination of the characteristic dimension L of the weld 10 during the study step 60 provides a priori information that thus makes it possible to facilitate the identification of the theoretical blocks 65 of the weld and the uniform Hooke tensors.

Additionally, during a subsequent simulation step 66, the operator enters characteristics relative to several types of different defects in the input peripheral 21 of the bulk inspection device 1. The information processing unit 24 next models each type of defect through a defect model 38, each defect model 38 comprising the characteristics associated with a particular type of defect, in particular the dimensions and orientation of the defect. The processing unit 24 then encapsulates each defect model 38 in a separate container 32.

The data processor 28 next implements the second software program 36. For each stored defect model 38, the processor 28 simulates the propagation of at least one ultrasound wave within the weld 10, as well as the influence of the defect on the propagation of each wave. To that end, the processor 28 uses the theoretical blocks 65 and the values of the elastic Hooke tensors determined experimentally during the previous step, and stored in the memory 26.

During a subsequent step 70 for determining reference waves, the processor 28 implements the first software program 34. Upon instruction from the first software program 34, the processor 28 deduces, from simulations done in step 66, data 40 representative of reference ultrasound waves. Each reference ultrasound wave is obtained for a given defect type. Each reference ultrasound wave has the same characteristic as a wave which, after its propagation in the weld 10, would be diffracted by the defect if the weld comprised the defect in question. For each defect model 38 stored in a software container 32, and for each simulation done, the memory 26 stores a list of data 40 associated with the simulation in the corresponding software container. Thus, at the end of the determination step 70, each software container 32 includes a set of lists 40 of data relative to a given defect type, also called imprint of simulated measurements associated with the defect. Consequently, each reference ultrasound wave is associated, in the memory 26, with a software container 32.

During a subsequent transmission step 72, the information processing device 20 sends the transmitter 16 a command signal to transmit incident ultrasound waves 73 toward the weld 10. The frequency of each transmitted incident wave 73 is for example substantially equal to 3 MHz. The beam of transmitted incident ultrasound waves 73 then propagates within the weld 10, as shown in FIG. 1. Each incident ultrasound wave 73 forms a diffracted ultrasound wave 75 after having crossed through the weld 10. In the example embodiment, part of the diffracted ultrasound waves 75 is diffracted by the defect 14.

During a subsequent measuring step 74, the receiver 18 receives the diffracted ultrasound waves 75. In the example embodiment, the receiver 18 in particular receives ultrasound waves diffracted by the defect 14 of the weld 10. The receiver 18 then determines a digital response signal Sr₂(t) and sends the digital response signal Sr₂(t) to the information processing unit 24.

In the alternative according to which the information processing device 20 is not connected to the receiver 18, the operator enters data measured by the receiver 18 in the entry peripheral 21, that data relating to the diffracted ultrasound waves 75.

The transmission 72 and measuring 74 steps are for example traditional steps in a method of the TOFD type of the prior art, known in itself.

During a subsequent comparison step 76, the operator enters the type and shape of the weld 10 into the entry peripheral 21. The processor 28 next implements the first software program 34. On instructions from the first software program 34, the processor 28 then compares the data contained in the digital response signal Sr₂(t) or entered by the operator to each imprint of simulated measurements stored in a software container 32.

In case of partial or total match between the data and a simulated measurements imprint, a subsequent step 78 for characterizing the defect is carried out.

If there is not a match between the data and the simulated measurement imprints, the processor 28 commands the retrieval interface 22, during a subsequent display step 80, to display a datum indicating that the inspected weld does not include a defect. The bulk inspection method then ends during a final step 82.

During the characterization step 78, upon instruction from the first software program 34, the processor 28 queries the software container 32 containing the measurement imprint identified during the comparison step 76. The corresponding software container 32 returns the defect model 38 that it includes to the processor 28.

During a subsequent step for displaying results 84, on instructions from the first software program 34, the processor 28 commands the retrieval interface 22 to display data indicating the presence of a defect in the weld, and data indicating the presence relevance level of the defect. The displayed relevance level depends on the match level previously determined during the comparison step 76. In the example embodiment, the processor 28 commands the retrieval interface 22 to display data indicating the presence of the defect 14 in the weld 10.

Based on the defect model 38 determined during the previous characterization step 78, the processor 28 further commands the retrieval interface 22 to display data indicating the detected defect type. In the example embodiment, the processor 28 commands the retrieval interface 22 to display data indicating the type of defect 14, in the case at hand a defect of the crack type.

The final step 82 is next carried out.

One can thus see that the bulk inspection method according to embodiments of the invention makes it possible to obtain a minute detection and characterization of the defects of a weld, with sufficient precision irrespective of the size of the grains of the metal material of the weld.

Alternatively, the simulation 66 and determination 70 steps for reference waves are carried out in parallel with the transmission 72 and measuring 74 steps, before the comparison step 76.

What is claimed is:

1-12. (canceled)

13. An ultrasound method for inspecting the bulk of a weld for the presence of defects, comprising:
studying the weld metallurgically,
experimentally dividing, based on the metallurgical study, the weld into a plurality of theoretical blocks, and jointly determining a uniform elastic Hooke tensor for each of the theoretical blocks, the theoretical blocks being chosen so that the elastic Hooke tensor of each of the blocks is substantially homogenous and anisotropic in the respective block;
simulating, by calculating a propagation of at least one incident ultrasound wave in the weld using the theoretical blocks and the determined elastic Hooke tensors, each of the incident ultrasound waves forming, after having crossed through the weld, a diffracted ultrasound wave;
determining at least one reference diffracted ultrasound wave as a function of the simulated propagation;
transmitting at least one of the at least one incident ultrasound waves in the weld;
measuring each of the diffracted ultrasound waves at least at one predetermined point; and
comparing each of the at least one reference diffracted ultrasound wave with each of the at least one measured diffracted ultrasound wave, to deduce therefrom whether the weld has a defect.

14. The method as recited in claim 13 wherein during the simulating, by calculating the propagation of the at least one incident ultrasound wave, weld defect types are modeled using defect models, each of the defect models comprising characteristics associated with a respective one of the defect types.

15. The method as recited in claim 14 wherein each of the defect models is encapsulated in a software container, each of the software containers further including a simulated measurement imprint associated with the respective defect type, each of the software containers being storable in a database.

16. The method as recited in claim 15 wherein each of the at least one reference diffracted ultrasound wave is associated with one of the software containers, the method further including:
characterizing the defect, during which the defect detected during the comparing is characterized; and
displaying results, during which the characterized defect is retrieved in the form of display data indicative of one of the defect types, and display data indicative of a related presence relevance level.

17. The method as recited in claim 13 wherein the experimentally dividing comprises transmitting at least one acoustic identification wave per family of the theoretical blocks.

18. The method as recited in claim 17 wherein the frequency of each of the acoustic identification waves varies during the transmission.

19. The method as recited in claim 17 wherein the transmitting at least one acoustic identification wave includes transmitting a plurality of identification acoustic waves, the frequencies of the transmitted identification waves being different in pairs.

20. The method as recited in claim 13 wherein each of the theoretical blocks has a volume larger than 0.1 mm³.

21. An ultrasound device for inspecting the bulk of a weld for the presence of defects, the weld including a plurality of theoretical blocks, the device comprising:
a transmitter configured to transmit at least one incident ultrasound wave in the weld, each of the at least one incident ultrasound wave forming, after having passed through the weld, a diffracted ultrasound wave;
a measurer configured to measure the at least one diffracted ultrasound wave at least at one predetermined point;
an information processor connected to the transmitter, the information processor being configured to determine at least one reference diffracted ultrasound wave, to compare each of the at least one reference diffracted ultrasound wave with each of the at least one measured diffracted ultrasound wave, and to deduce therefrom whether the weld has a defect, the processor configured to experimentally determine the theoretical blocks of the weld experimentally, as well as elastic Hooke tensors associated with the theoretical blocks, to be simulated by calculating a propagation of the at least one incident ultrasound wave by using the experimentally determined elastic Hooke tensors and to deduce each of the at least one reference diffracted ultrasound wave therefrom.

22. The ultrasound device as recited in claim 21 wherein the processor includes a storage configured to store a database comprising a plurality of software containers.

23. The ultrasound device as recited in claim 22 wherein each of the software containers includes a defect model comprising characteristics associated with a defect type, and a simulated measurement imprint associated with the defect type.

24. The ultrasound device as recited in claim 21 further comprising a characterizer for characterizing the detected defects and a display for displaying results of the inspection.
